(19) United States
(12) Patent Application Publication
(10) Pub. No.: US 2022/0372996 A1
(43) Pub. Date: Nov. 24, 2022

(54) PISTON ACCUMULATOR

(71) Applicant: HYDAC TECHNOLOGY GMBH, Sulzbach/Saar (DE)

(72) Inventors: Herbert BALTES, Losheim (DE); Peter KLOFT, Ransbach-Baumbach (DE)

(21) Appl. No.: 17/774,516

(22) PCT Filed: Oct. 29, 2020
(86) PCT No.: PCT/EP2020/080366

§ 371 Date: May 5, 2022

(30) Foreign Application Priority Data
Nov. 7, 2019 (DE) 10 2019 007 711.3

(51) Int. Cl. F15B 1/24

(52) U.S. Cl. CPC F15B 1/24; F15B 2201/205; F15B 2201/312

(57) ABSTRACT

A piston accumulator having an accumulator housing (4) and a separating piston (10), which is guided longitudinally displaceable therein, which separates two media chambers (12, 14) from each other and which has a dual sealing system (16), wherein one of the sealing systems (18) faces one media chamber (12) and the other sealing system (20) faces the other media chamber (14), wherein at the location (58) a compensation device is at least partially accommodated in the separating piston (10) between the two sealing systems (18, 20), which compensation device enables hydrostatic pressure compensation between the two sealing systems (18, 20) to prevent an undesirable pressure buildup during operation.

The invention relates to a piston accumulator having an accumulator housing and a separating piston guided longitudinally displaceable therein, which separates two media chambers from each other and which has a dual sealing system, wherein one of the sealing systems faces one media chamber and the other sealing system faces the other media chamber.

DE 102 48 823 A1 discloses a hydraulic accumulator in the form of a piston accumulator having a piston that can be moved in the accumulator housing in the axial direction thereof and that separates a gas end from a fluid end of the accumulator housing, on the circumference of which piston guide elements provided for interaction with the wall of the accumulator housing and a plurality of sealing elements are present, wherein offset in the axial direction relative to the guide elements, in the circumferential section of the piston located therebetween, a pressure-compensation channel is provided, which forms a fluid path between the fluid end and a space on the piston circumference, which is located between the guide element located nearest to the fluid end and the sealing element located nearest thereto in the axial direction, wherein a device in the form of an orifice or nozzle is provided in the pressure-compensation channel to reduce the passage cross-section thereof.

The known solution is based on the consideration that dirt particles, which may be contained in the hydraulic oil on the fluid end, have a negative effect on the long-term behavior of the hydraulic accumulator and on the operating behavior of the sealing and guiding systems between the piston circumference and the inner wall of the accumulator housing. The pressure-compensation channel in the separating piston counteracts the above problems because there is no longer any pressure difference at the guide element during the piston movements occurring in operation, and thus no volume flow, which may be contaminated with dirt particles, is generated. Because the passage cross-section of the pressure-compensation channel is reduced by the orifice or nozzle, only a small volume of fluid is involved in the process of pressure compensation in that way.

In practice, it has been shown that in the hydropneumatic piston accumulators mentioned here with a double seal system for the separating piston, a pressure buildup occurs between the two seals or seal systems during operation, which pressure buildup can reach that maximum operating pressure of the accumulator or can even exceed it owing to so-called pumping effects. As a result, various effects can occur, such as operating noise, and extrusion of the sealing systems, up to and including jamming of the piston. These problems are not solved using the differently acting pressure-compensation channel according to DE 102 48 823 A1.

Based on this prior art, the invention addresses the problem of further improving the known piston accumulator solutions in such a way that the pressure buildup described above and its undesirable effects cannot occur.

This problem is solved by a piston accumulator having the features of claim 1 in its entirety.

In accordance with the characterizing part of claim 1, a compensation device is at least partially accommodated in the separating piston between the two sealing systems of the dual sealing system, which compensation device enables hydrostatic pressure compensation between the two sealing systems to prevent an undesirable pressure buildup during operation, preventing the undesirable pressure buildup having the described adverse effects from occurring.

Rather, the compensation device according to the invention between the two sealing systems permits the zone of pressure buildup between the one sealing system facing the one media chamber having the working gas, to undergo pressure compensation in the direction of the zone of pressure reduction between this compensation device and the other sealing system facing the other media chamber having the liquid, typically hydraulic oil. Contrary to the known solution according to DE 102 48 823 A1, no pressure difference is eliminated at the fluid-end guide element to prevent the ingress of dirt particles, but rather a true hydrostatic pressure compensation is brought about between the two sealing systems of the dual sealing system, which are located between the two guide systems of the separating piston towards both end regions of the separating piston. Owing to the hydrostatic pressure compensation, there is no longer an unacceptably high-pressure buildup during operation, so that noise is prevented just like the extrusion of the seals and/or the jamming of the separator piston in the accumulator housing.

The fluid in the pressure buildup zone also provides improved fluid lubrication for the sealing system facing the end of the separator piston with the working gas, which is particularly important when, instead of well-lubricating liquids such as hydraulic oils, aqueous liquids such as HFC, having significantly reduced lubricity in comparison, are used.

In a preferred exemplary embodiment, provision is made for the compensation device to be accommodated in an annular groove of the separating piston and to be formed from a circumferential sealing ring, two projecting annular segments of which are in contact with the inside of the accumulator housing, which annular segments between them delimit an annular chamber, which exits from the sealing ring while connected via at least one compensation channel to the inside of the sealing ring in a media-conveying manner. Preferably, the mode of operation of the compensation device is similar to a check valve having a throttling effect, which check valve opens from its closed position in the direction of the other media chamber having the liquid. In this way, a liquid-end seal having a pressure-relief function and having a surprisingly improved lubrication for the gas-end seal of the separator piston in relation to the accumulator housing is achieved.

In a further preferred exemplary embodiment, provision is made for the respective channel of the sealing ring, starting from the annular chamber, to be inclined by a notional angle of inclination of approximately 30° to 50°, preferably of 40°, towards the support ring and in the direction of the interior of the piston towards the end that delimits the other media chamber. This facilitates the flow of fluid into the channel, which in turn facilitates the desired compensation of the pressure between the three sealing rings of the different sealing systems. The seal design permits a minimal liquid transfer into the space between the seals; but ensures safe relief of any pressures building up between these seals. In this respect, the piston accumulator according to the invention also permits the separating piston to run at higher speeds.

Further advantageous embodiments are the subject matter of the other dependent claims.

Below, the piston accumulator according to the invention will be explained in more detail with reference to the drawing. In the figures, in general view, not to scale,

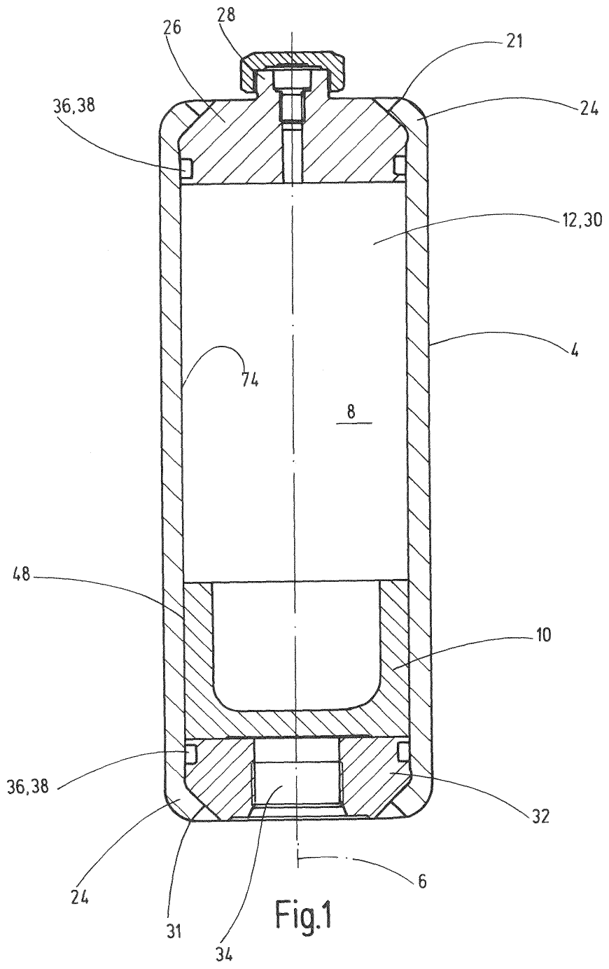

FIG. 1 shows a schematically simplified longitudinal section through a piston accumulator according to the invention, which for reasons of simplicity shows the separating piston without guide device, sealing device and compensation device;

FIG. 2 shows an enlarged (compared to FIG. 1) partial section of the separating piston guided in the piston accumulator, which separating piston is shown for reasons of simplicity without any compensation device, which is otherwise received in the placeholder shown as a kind of blank space; and

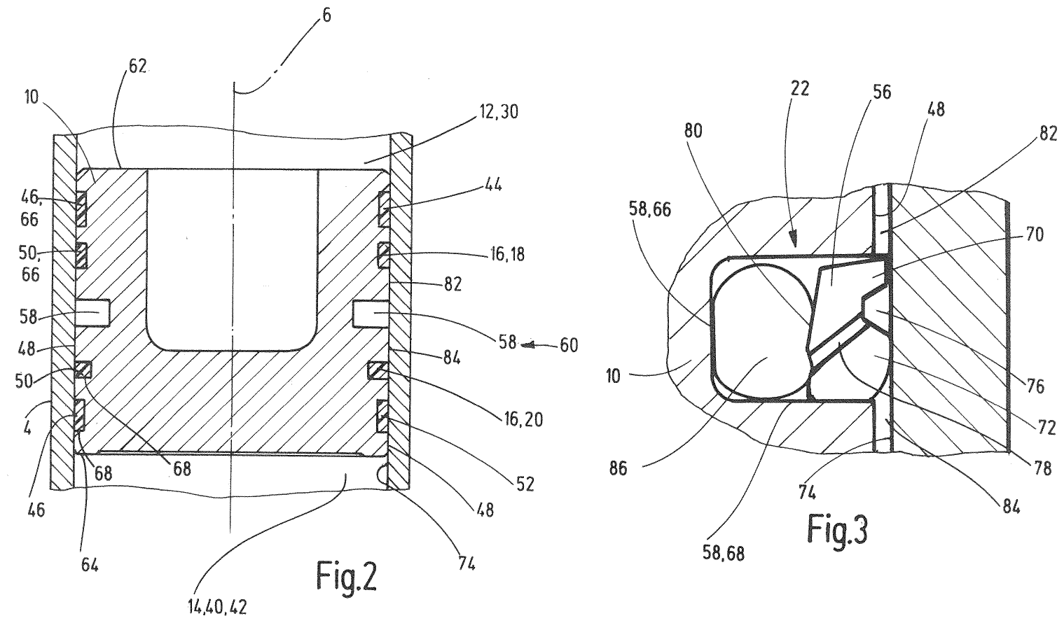

FIG. 3 shows an enlarged (compared to FIG. 2) partial section of the compensation device received in the separating piston at the location of the placeholder according to FIG. 2.

FIG. 1 shows a piston accumulator according to the invention having an accumulator housing 4, which has a cylindrical interior 8 extending along its longitudinal axis 6, and a separating piston 10 guided therein for longitudinal movement. The separator piston 10 separates one media chamber 12 from another media chamber 14 in the accumulator housing 4 and has a dual sealing system 16 (FIG. 2). One sealing system 18 of the dual sealing system 16 is closer to the one media chamber 12 and the other sealing system 20 of the dual sealing system 16 is closer to the other media chamber 14. Between the two sealing systems, a compensation device 22 (FIG. 3) is at least partially accommodated in the separating piston 10. To prevent an undesirable pressure buildup during operation, the compensation device 22 enables hydrostatic pressure compensation between the two sealing systems 18, 20.

An end insert 26 secured by a flared lap 24, closes the cylindrical accumulator housing 4 at one end 21, which end insert 26 has a concentrically disposed gas filling port 28, which can be used to fill the one media chamber 12, which is also delimited by the insert 26, with a working gas 30 pressurized with a precharge pressure. At the opposite end 31, the accumulator housing 4 is closed by a further end insert 32, which is also secured by means of a flared lap 24 and has a central opening 34 for a fluid guide of a hydraulic circuit, wherein said fluid guide is not shown in the figures. Each end insert 26, 32 has an annular groove 36 on its outer circumference, in which a sealing ring 38 is provided to seal the respective end inserts 26, 32 from the accumulator housing 4. The one media chamber 12 contains nitrogen as the working gas 30 and the other media chamber 14 contains a liquid 40 in the form of hydraulic oil 42.

The separating piston 10 is largely guided at its two free end regions by means of a respective circumferential guide band 44, 52 (FIG. 2) in the accumulator housing 4. The guide bands 44, 52 are each accommodated in a circumferential annular groove 46 on the outer circumference 48 of the separator piston 10, between which guide bands 44, 52 the double seal system 16 is disposed. Thus, one sealing system 18 is accommodated axially offset in the direction of the liquid space 14 relative to one guide band 44 in an annular groove 50 on the outer circumference 48 of the separator piston, and the other sealing system 20 is accommodated axially offset in the direction of the gas space 12 relative to the other guide band 52 in an annular groove 50 on the outer circumference 48 of the separator piston, wherein the one sealing system 18 and the other 20 sealing system are also axially spaced apart.

The compensation device 22, which can be regarded as a kind of circumferential sealing ring 56 and which is disposed between the two sealing systems 18, 20, is also accommodated in an annular groove 58 on the outer circumference 48 of the separating piston.

The annular groove 58 inserted in the outer circumference 48 in the separating piston 10 for accommodating the compensation device 22 is provided in the central region 60 of the separating piston with respect to the axial length of the separating piston 10, preferably disposed centrally between the two free end faces 62, 64 of the separating piston 10 facing each other. The annular grooves 46, 50, 58 for the compensation device 22, the respective sealing system 18, 20 and the respective guide band 44, 52 are provided on the outer circumference 48 of the separating piston and are formed in cross-section as a polygon having walls 66, 68 at right angles to one another. In this case, the annular grooves 46, 50 for the guide bands 44, 52 and the sealing system 18 closest to the gas space 12, have a groove base 66 that is wider viewed in the axial direction than their annular side walls 68 are high viewed in the radial direction. In contrast, the annular grooves 50, 58 for the compensation device 22 and the sealing system 20 closest to the liquid space 14, have annular side walls 68 that are higher viewed in the radial direction than their groove base 66 is wide viewed in the axial direction.

The sealing ring 56 of the compensation device 22 has two projecting annular segments 70, 72, which are in contact with the inner wall 74 of the accumulator housing 4 to seal the gas space 12 from the liquid space 14. The annular segments 70, 72 delimit between each other an annular chamber 76, which exits via at least one compensation channel 78 connected to the inside 80 of the sealing ring 56 in a media-conveying manner from the sealing ring 56 into the annular groove 58 for accommodating the compensation device 22.

The zone 82 of the pressure buildup is located between the one sealing system 18, which is closest to the gas space 12, and the compensation device 22. The zone 84 of possible pressure reduction is located between the compensation device 22 and the other sealing system 20, which is closest to the liquid space 14. The mode of operation of the compensation device 22 is approximately similar to that of a check valve having a throttling effect, which opens from its closed position in the direction of the liquid space 14.

The sealing ring 56 of the compensation device 22 circumferential on the separating piston 10, rests on its inside 80 on a circumferential support ring 86, which is also accommodated in the annular groove 58 for the compensation device 22. The support ring 86 is formed as an elastomeric O-ring and is used as a preloading element for the sealing ring 56 of the compensation device 22. The sealing ring 56 of the compensation device 22 that encompasses the O-ring, is preferably formed of PTFE (polytetrafluoroethylene) material, but alternatively may be formed of a thermoplastic or PU (polyurethane) material. The sealing rings 18, 20 of the dual sealing system 16 are likewise formed from one of these materials.

The seal formed by means of the sealing ring 56 of the compensation device 22 in combination with the support ring 86 between the two media chambers 12, 14 via the separating piston 10 in conjunction with the accumulator housing 4 is characterized by a high sealing effect, low friction without stick-slip effect, minimal breakaway forces and high wear resistance and temperature resistance.

The angle between the radially extending side walls 68 of the annular groove 58 for the compensation device 22 and the respective channel 78 formed in the sealing ring 56, is approx. 40°, wherein the channel 78 starting from the annular chamber 76 and extending obliquely to the radial direction in the direction of the piston interior, i.e. in the direction of the support ring 86, is inclined towards that end face 64 of the piston 10, which also delimits the liquid space 14. Instead of the single channel 78 shown in FIG. 3, multiple channels, as well as other interruptions, such as a perforation, can also be introduced into the sealing ring 56 of the compensation device 22. Preferably, the channels are then disposed diametrically opposite from each other with respect to the longitudinal axis 6 of the accumulator.

The one annular segment 70 of the sealing ring 56 of the compensation device 22, which is formed in the way of a sealing lip and is adjacent to the space 12 having the working gas 30, forms a smaller contact surface with the inner wall 74 of the accumulator housing 4 than the adjacent contact surface of the further annular segment 72, which is spherical and adjacent to the liquid space 14. The cross-section of the annular chamber 76 co-delimited by one annular segment 70 and the other 72 annular segment, is trapezoidal in shape.

A separating piston 10 having three independently operating sealing systems 16, 22 with sealing rings 18, 20, 56 in terms of the solution according to the invention also permits other fillings of the media chambers 12, 14 separated from each other via the separating piston 10 in the accumulator housing 4, i.e. in addition to gas/liquid also liquid/liquid, gas/gas or liquid/gas. By simply reversing the direction of the pressure-conveying channel 78, the pressure-compensation function can be reversed as described above.

1. A piston accumulator having an accumulator housing (4) and a separating piston (10), which is guided longitudinally displaceably therein, which separates two media chambers (12, 14) from each other and which has a dual sealing system (16), wherein one of the sealing systems (18) faces one media chamber (12) and the other sealing system (20) faces the other media chamber (14), characterized in that a compensation device (22) is at least partially accommodated in the separating piston (10) between the two sealing systems (18, 20), which compensation device (22) enables hydrostatic pressure compensation between the two sealing systems (18, 20) to prevent an undesirable pressure buildup during operation.

2. The piston accumulator according to claim 1, characterized in that the one media chamber (12) comprises a working gas (30), such as nitrogen, and the other media chamber (14) comprises a liquid (40), such as hydraulic medium, and that preferably the sealing system (20) assigned to the other media chamber (14) with the liquid (40), is lubricated by this liquid (40).

3. The piston accumulator according to claim 1 or 2, characterized in that the separating piston (10) is co-guided towards its free end regions by guide bands (44, 52) in the accumulator housing (4), wherein the dual sealing system (16) is arranged between the guide bands (44, 52).

4. The piston accumulator according to claim 1, characterized in that the compensation device (22) is accommodated in an annular groove (58) of the separating piston (10) and is formed from a circumferential sealing ring (56), two projecting annular segments (70, 72) of which are in contact with the inside (74) of the accumulator housing (4), which annular segments (70, 72) between them delimit an annular chamber (76), which exits from the sealing ring (56) while connected via at least one compensation channel (78) to the inside (80) of the sealing ring (56) in a media-conveying manner.

5. The piston accumulator according to claim 1, characterized in that the zone (82) of pressure buildup is located between the one sealing system (18) facing the one media chamber (12), and the compensation device (22), and the zone (84) of possible pressure reduction is located between this compensation device (22) and the other sealing system (20) facing the other media chamber (14).

6. The piston accumulator according to claim 1, characterized in that the mode of action of the compensation device (22) is similar to that of a check valve having a throttling effect, which valve opens from its closed position in the direction of the other media chamber having the liquid (40).

7. The piston accumulator according to claim 1, characterized in that the sealing ring (56) circumferential on the separating piston (10) rests on its inside (80) on a circumferential support ring (86), which is also received in the annular groove (58) of the separating piston (10).

8. The piston accumulator according to claim 1, characterized in that the respective channel (78) of the sealing ring (56), starting from the annular chamber (76), is inclined by a notional angle of inclination of approximately 30° to 50°, preferably of 40°, towards the support ring (86) and in the direction of the interior of the piston (10) towards the end that delimits the other media chamber (14).

9. The piston accumulator according to claim 1, characterized in that the one annular segment (70) of the sealing ring (56), which is adjacent to the one media chamber (12), forms a smaller contact surface with the inner wall (74) of the accumulator housing (4) than the adjacent contact surface of the further annular segment (72), which is preferably spherical in shape.

10. The piston accumulator according to claim 1, characterized in that the annular chamber (76) of the circumferential sealing ring (56) is trapezoidal viewed in cross-section.
